(19) United States
(12) Patent Application Publication
(10) Pub. No.: US 2014/0193993 A1
(43) Pub. Date: Jul. 10, 2014

(54) PLUG CONNECTOR HAVING A RELEASING MECHANISM

(71) Applicant: HON HAI PRECISION INDUSTRY CO., LTD., New Taipei (TW)

(72) Inventors: JIN-HUA MENG, Kunshan (CN); SHU-ZHONG PENG, Kunshan (CN); YUN-CHENG HOU, New Taipei (TW)

(73) Assignee: HON HAI PRECISION INDUSTRY CO., LTD., New Taipei (TW)

(21) Appl. No.: 13/871,228

(22) Filed: Apr. 26, 2013

(30) Foreign Application Priority Data
Jan. 9, 2013 (CN) 201310007458.5
Jan. 9, 2013 (CN) 201310007488.6

(51) Int. Cl. H01R 13/633

(52) U.S. Cl. CPC H01R 13/633
USPC 439/352

(57) ABSTRACT

A plug connector to be inserted into a receptacle cage having a latching tab includes a housing and a releasing mechanism mounted on the housing. The housing has a top wall, a bottom wall and two side walls interconnecting the top wall and the bottom wall together. The housing includes a first flange extending a first preselected distance from the top wall and a second flange extending a second preselected distance from the bottom wall. A width of the second flange is larger than a width of the first flange. The releasing mechanism comprises a pair of actuator arms movably attached to the sidewalls along a mating direction of the plug connector and a horizontal portion integrally connected between the actuator arms.

### BACKGROUND OF THE INVENTION

1. Field of the Invention

The present invention generally relates to a plug connector, and more particularly relates to a releasing mechanism of the plug connector.

2. Description of Related Art

U.S. Patent Application Publication No. 2012/0220147, published on Aug. 30, 2012, discloses a plug connector configured for latching with a receptacle cage having a latching tab. The plug connector includes a housing defining two opposite sidewalls and a releasing mechanism assembled to the housing. The releasing mechanism includes a pair of substantially parallel, separately formed actuator arms linked together by a pull member. The actuator arms are movably attached to the sidewalls. Each of the actuator arms includes a narrowed and protruded actuating end adapted for releasing the latching tab of the receptacle cage from the plug connector when the actuator arm moves from a first position to a second position. The actuator arm has a bend portion extending backwardly and inwardly from a rear end thereof. Additionally, when the plug connector is to be extracted from the receptacle, the actuating end may not uplift sufficiently to deflect the latching tab due to its inherent structural design.

Hence, a plug connector having an improved releasing mechanism is desired.

### SUMMARY OF THE INVENTION

Accordingly, an object of the present invention is to provide a plug connector having an improved releasing mechanism.

In order to achieve the above-mentioned object, a plug connector configured for latching engagement with a receptacle cage having an inwardly extending latching tab comprises a housing defining a top wall, a bottom wall, two opposite sidewalls, and a releasing mechanism assembled to the housing. The top wall extends a preselected length to define a first flange, and the bottom wall extends a preselected length to define a second flange. A width of the first flange is smaller than a width of the second flange. The releasing mechanism comprises a pair of actuator arms movably attached to the sidewalls along a mating direction of the plug connector and a horizontal portion integrally connected between the actuator arms.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a plug connector having a releasing mechanism in accordance with a first embodiment of the present invention;

FIG. 2 is a partially exploded view of the plug connector as shown in FIG. 1;

FIG. 3 is another partially exploded view of the plug connector as shown in FIG. 1;

FIG. 4 is similar to FIG. 3, but taken from another view;

FIG. 5 is a perspective view of the releasing mechanism as shown in FIG. 1;

FIG. 6 is an assembled perspective view showing a plug connector having a releasing mechanism in accordance with a second embodiment of the present invention;

FIG. 7 is a partially exploded view of the plug connector as shown in FIG. 6;

FIG. 8 is another partially exploded view of the plug connector as shown in FIG. 6;

FIG. 9 is similar to FIG. 8, but taken from another view;

FIG. 10 is a perspective view of the releasing mechanism as shown in FIG. 6.

### DETAILED DESCRIPTION OF THE PREFERRED EMBODIMENT

Reference will now be made to the drawing figures to describe the present invention in detail.

This description of preferred embodiments is intended to be read in connection with the accompanying drawings, which are to be considered part of the entire written description of this invention. In this description, the plug connector 100,100′ is an optical-electrical connector connected with an optical cable 4,4′. Typically, the plug connector 100,100′ may be construed to an electrical connector or a transceiver and so on.

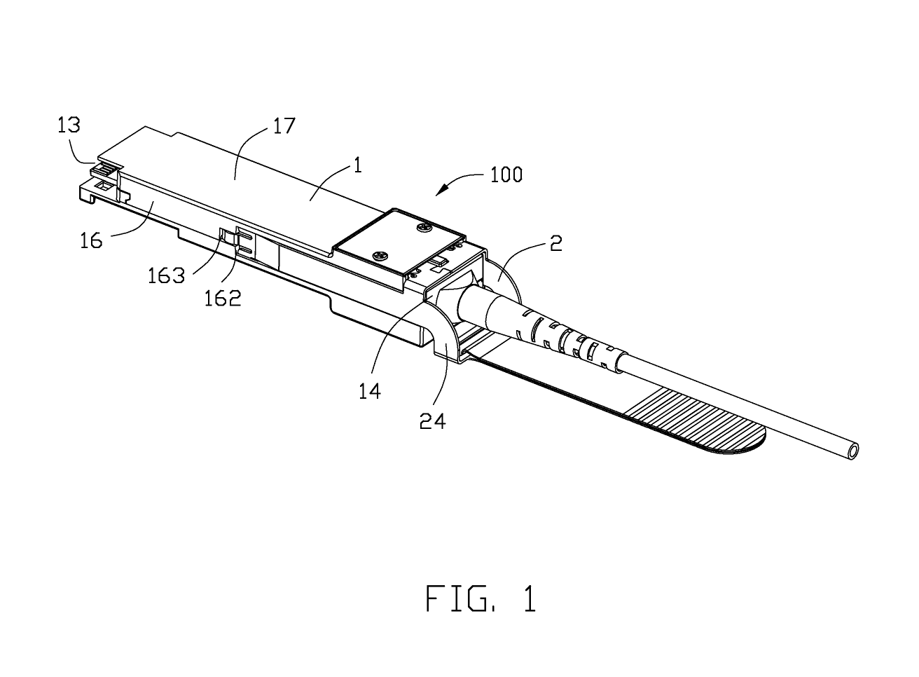

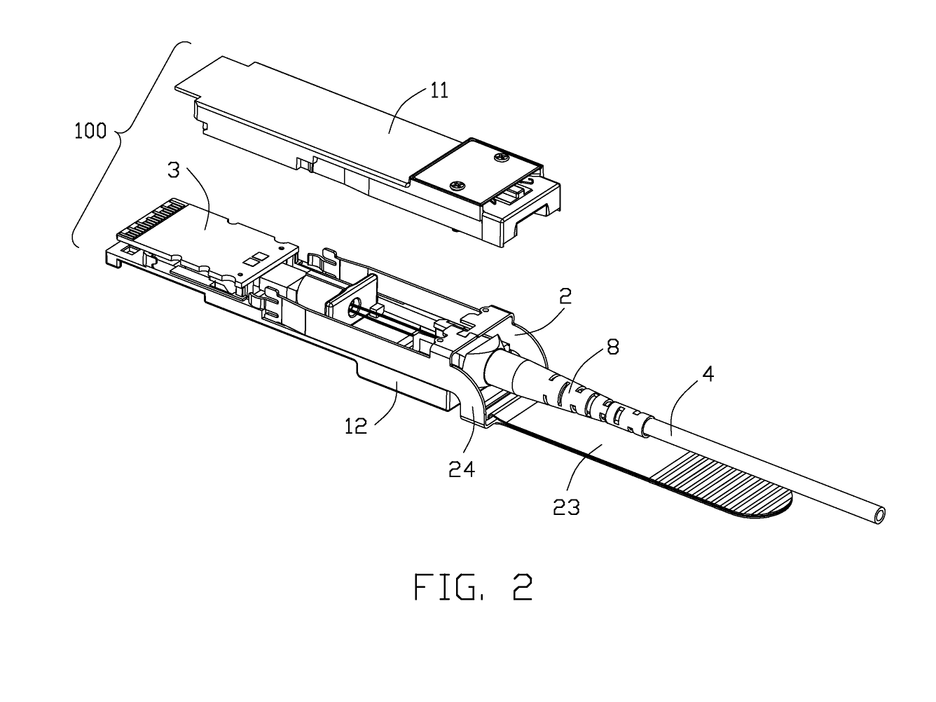

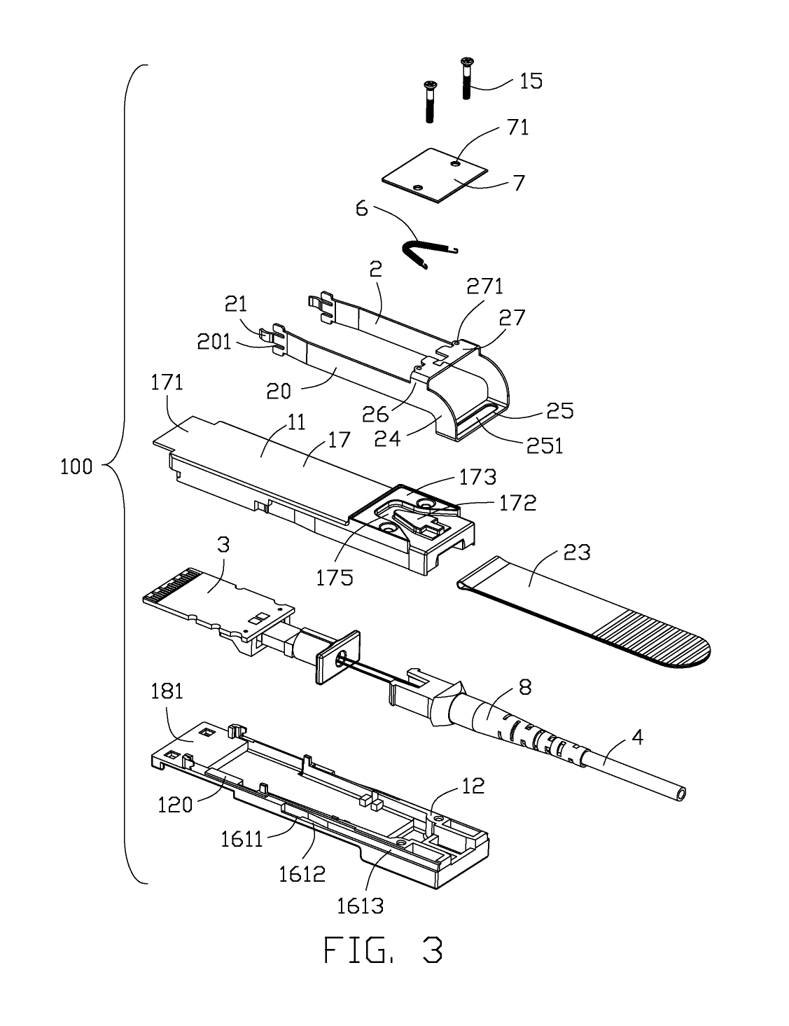

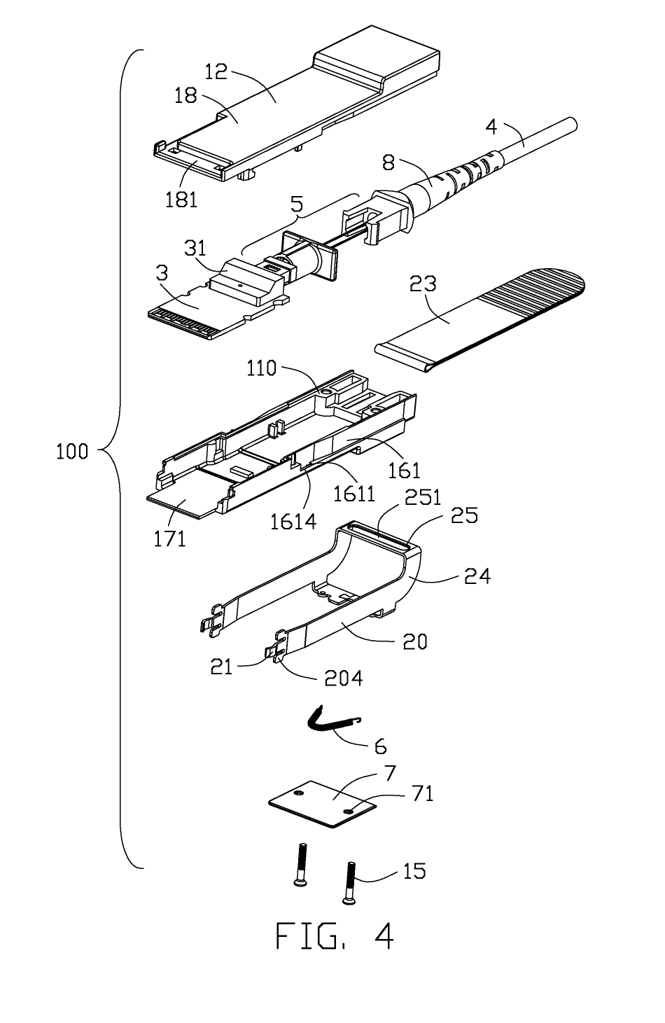

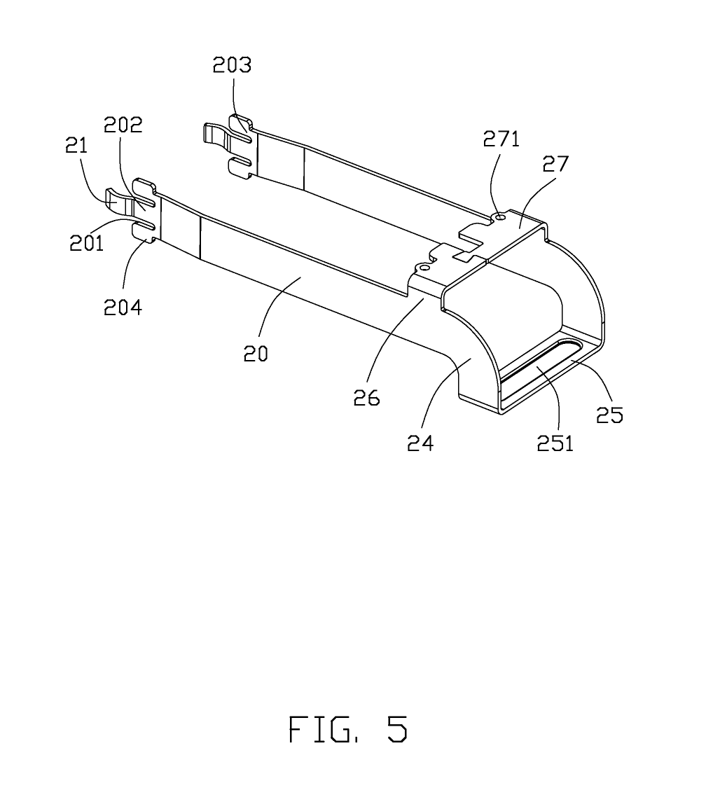

Referring to FIGS. 1 to 5 as a first embodiment of a plug connector 100 configured for latching engagement with a receptacle cage (not shown) having an inwardly extending latching tab (not shown). The plug connector 100 in accordance with the present invention comprises a housing 1 having a base 12 and a cover 11 attached to an upper portion of the base 12, and a releasing mechanism 2 assembled to the housing 1 which includes a pair of substantially parallel actuator arms 20. The base 12 defines a receiving space (not labeled). The plug connector 100 further includes a printed circuit board 3 received in the receiving space, a resilient member 6 assembled to the cover 11, an optical member 31, and an optical cable 4 having a plurality of optical fibers (not shown). The optical member 31 is located around the area of the printed circuit board 3. There is a mechanical member 5 is located behind the optical member 31 which is used to fix the optical cable 4, and a boot 8 encloses a front portion of the optical cable 4.

The housing 1 of the plug connector 100 has a front portion 13 configured for connecting with the printed circuit board 3 to achieve electrical transmission with the receptacle cage (not shown), and a rear portion 14 configured for connecting with the optical cable 4. The housing 1 is preferably made by metal material. The base 12 and the cover 13 have opposite mating surfaces 110,120 thereof. The base 12 is mated with the cover 13 by at least one holding member 15. In this embodiment, the holding member 15 is screw. The housing 1 also normally includes a top wall 17, a bottom wall 18 and two opposite sidewalls 16. The top wall 17 extends a preselected length to define a first flange 171, and the bottom wall 18 extends a preselected length to define a second flange 181. A width of the first flange 171 is smaller than a width of the second flange 181.

The top wall 17 of the housing 1 defines a resisting part 172 and a stepped portion 173. A curved slot 175 is formed between the resisting part 172 and the stepped portion 173. The resilient member 6 has two free ends could be received in the curved slot 175. Accordingly, each of the free ends of the resilient member 6 has a hook (not labeled) adapted for hooking the releasing mechanism 2 directly. In this design, the resilient member 6 is a compression spring. In the preferred embodiment, both the resilient member 6 and the curved slot 175 are disposed into a V-shaped. Typically, in accordance with the present invention, the resilient member 6 and the curved slot 175 are designed into a U-shaped (or other shapes) configuration with the same effect. The resilient member 6 would be in an extended state when it is moved from a latching position to a releasing position. Meanwhile, when the actuator arms 20 are located at the releasing position, the resilient member 6 could provide a return force to restore the actuator arms 20 to the latching position. A plate 7 is mounted onto the housing 1 adapted for covering the curved slot 175. The plate 7 covers the compression spring for preventing the resilient member 6 escaping from the curved slot 175. The plate 7 defines at least one mounting hole 71 for receiving the holding member 15. The holding member 15 could be locked onto the resisting part 172 or the stepped portion 173. In the embodiment, the holding member 15 is screwed through the mounting hole 71 to fasten the cover 11 to the base 12 by riveting or soldering or screw connection.

Each of the sidewalls 16 defines an indentation 163 opening towards the rear portion 14, and an elongated recess 161 located at an outer surface thereof extending along a front-to-rear direction from the indentation 163. A width of the indentation 163 is smaller than a width of the recess 161 to form a shoulder portion 162 therebetween. The latching tap resists the shoulder portion 162 so that the plug connector 100 could be latched with the receptacle cage.

The releasing mechanism 2 is formed by stamping and bending a piece of metal sheet. The releasing mechanism 2 comprises a horizontal portion 25 integrally connected between the actuator arms 20, bend portions 24 linking to the horizontal portion 25, and a pull member 23 attached to the horizontal portion 25. In the invention, bend portions 24 respectively extending from rear ends of the actuator arms 20 toward the bottom wall 18 and rearwardly, and the bend portion 24 are designed into an arc-shaped. The bend portion 24 lies on a vertical main plane of the actuator arm 20. Typically, the bend portion 24 has a width equal to the actuator arm 20. The horizontal portion 25 defines a slot 251 for connecting with the pull member 23. In this embodiment, the pull member 23 is a drawstring which could form a mechanical connection with the horizontal portion 25. More particularly, the pull member 23 opposites to the optical cable 4 to provide an actuating force which the releasing mechanism 2 moves along a front-to-rear direction. Such design not only saves strength but also easily to operate. The releasing mechanism 2 further includes a pair of protrusion portions 26 extending toward the top wall 17 from the corresponding actuator arm 20 and a connecting portion 27 connected between two protrusion portions 26. The protrusion portions 26 are located at the front of the bend portions 24 and the horizontal portion 25. The protrusion portions 26 extend along an opposite direction to the bend portion 24 relative to the actuator arms 20. In this embodiment, the connecting portion 27 includes a first portion (not labeled) and a second portion (not labeled) engagement with the first portion. It is convenient to manufacture the releasing mechanism.

Each of the actuator arms 20 comprises a narrowed and protruded actuating end 21 adapted for releasing the latching tab of the receptacle cage when the actuator arm 20 moves from the latching position to the releasing position, and defining slits 201 extending rearwardly beside the actuating end 21 to increase an elastic deformation length of the actuating end 21. In this embodiment, the actuating end 21 designed into an arc-shaped, and each of the actuating arms 20 defines a pair of slits 201. Without a doubt, each of the actuating arms 20 could have a slit 201 or more. The actuating end 21 is adjacent to the slit 201, the pair of slits 201 being defined axial symmetry with each other. When the plug connector 100 configured for latching engagement with a receptacle cage, the actuating end 21 is not protruded out of the side walls 16. However, when the releasing mechanism 2 moves backwardly, the actuating end 21 is out of the corresponding sidewall 16. Each of the actuator arms 20 further includes a first part 202 located between the pair of slits 201, a second part 203 located outside of the slit 201. The first part 202 and the second part 203 are separated at the front of the actuating arm 20. The first part 202 has a width measured along an up-to-down direction equal to a width of the actuating end 21 along the direction.

A pair of restriction tabs 204 are formed at the outside of the second part 203 of each actuator arms 20. Typically, each of the actuating arms 20 may have one tab 204 or more tabs 204 as long as it is contribute to make the latching tabs separate from the plug connector 100. Each of the sidewalls 16 has a limiting groove 1611 for receiving corresponding tab 204. The limiting groove 1611 has a resisting wall 1614. When the actuator arms 20 move backwardly from a latching position to a releasing position, the resisting wall 1614 of the limiting groove 1611 could make the tab 204 received in the limiting groove 1611. The limiting groove 1611 locates at the front of the recess 161. The recess 161 further includes a channel 1613 locates at a rear end of the recess 161 and an inclined groove 1612 connecting with the limiting groove 1611 and channel 1613. The depth of the channel 1613 is smaller than the limiting groove 1611. In this description, each of the actuator arms 20 defines a pair of tabs 204.

In this description, a releasing mechanism 2 comprises a horizontal portion 25 integrally connected between the actuator arms 20, bend portions 24 linking to the horizontal portion 25, and a pull member 23 attached to the horizontal portion 25. In the invention, it provides the horizontal portion 25 to connected with the pull member 23 for making the structure more stable. Additionally, the pull member 23 and the horizontal portion 25 is mechanical connection for reducing the cost.

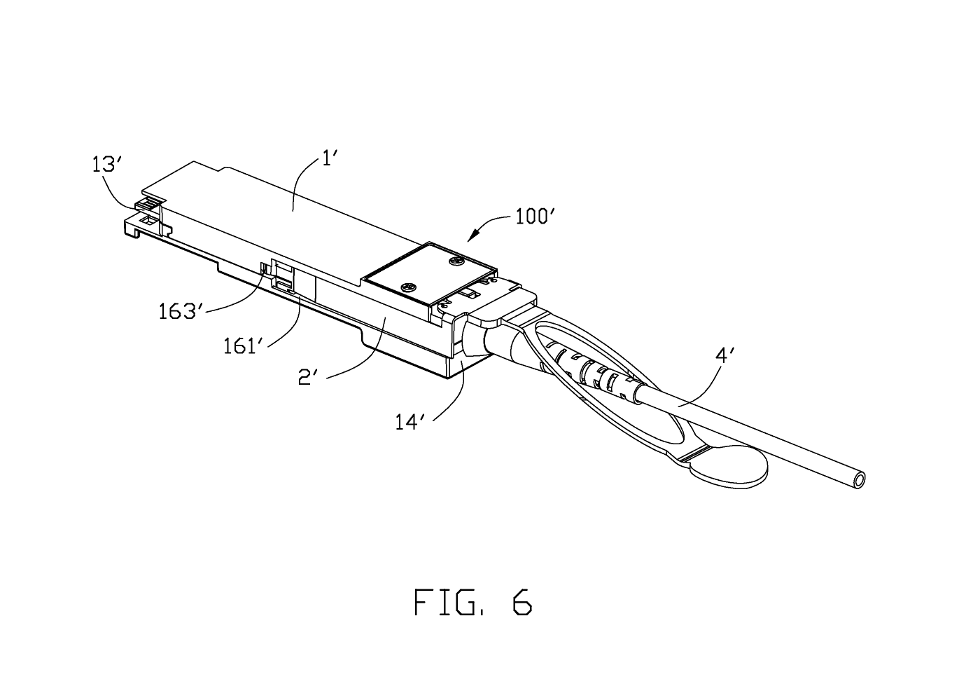

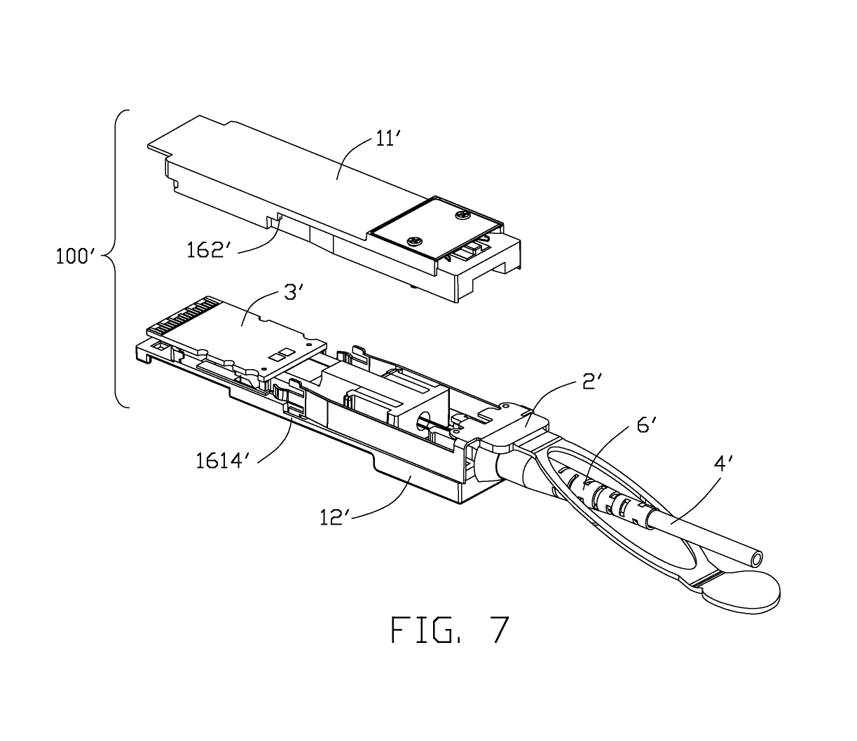

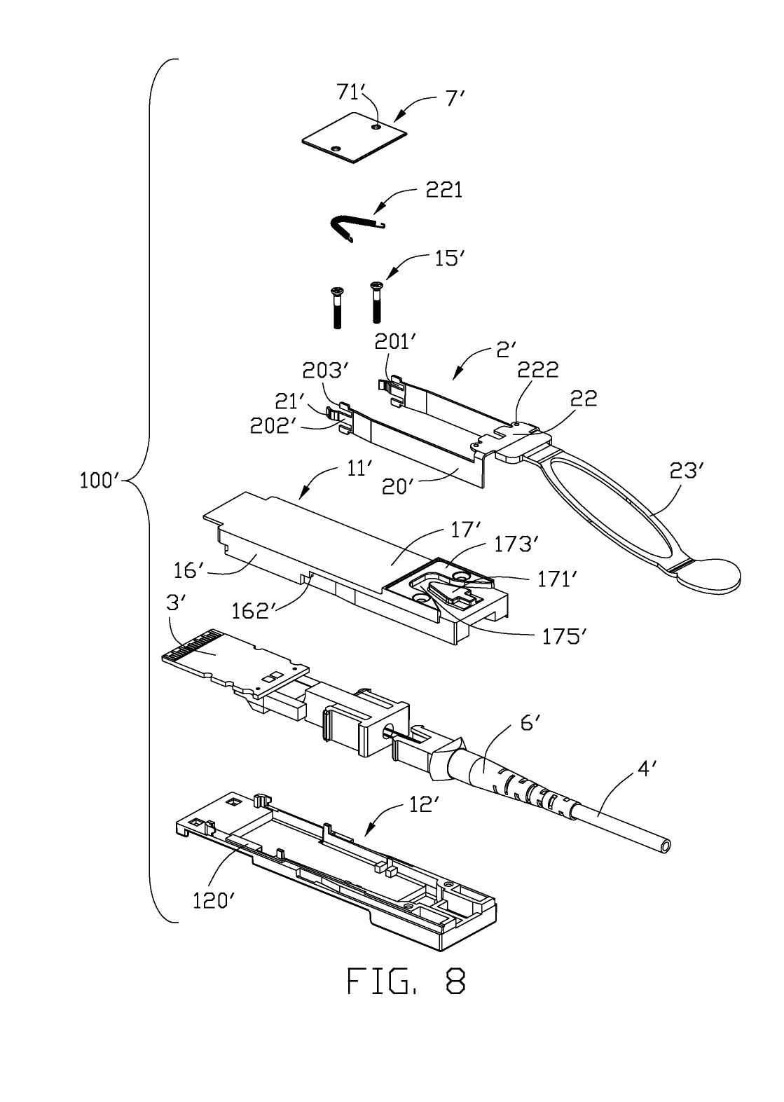

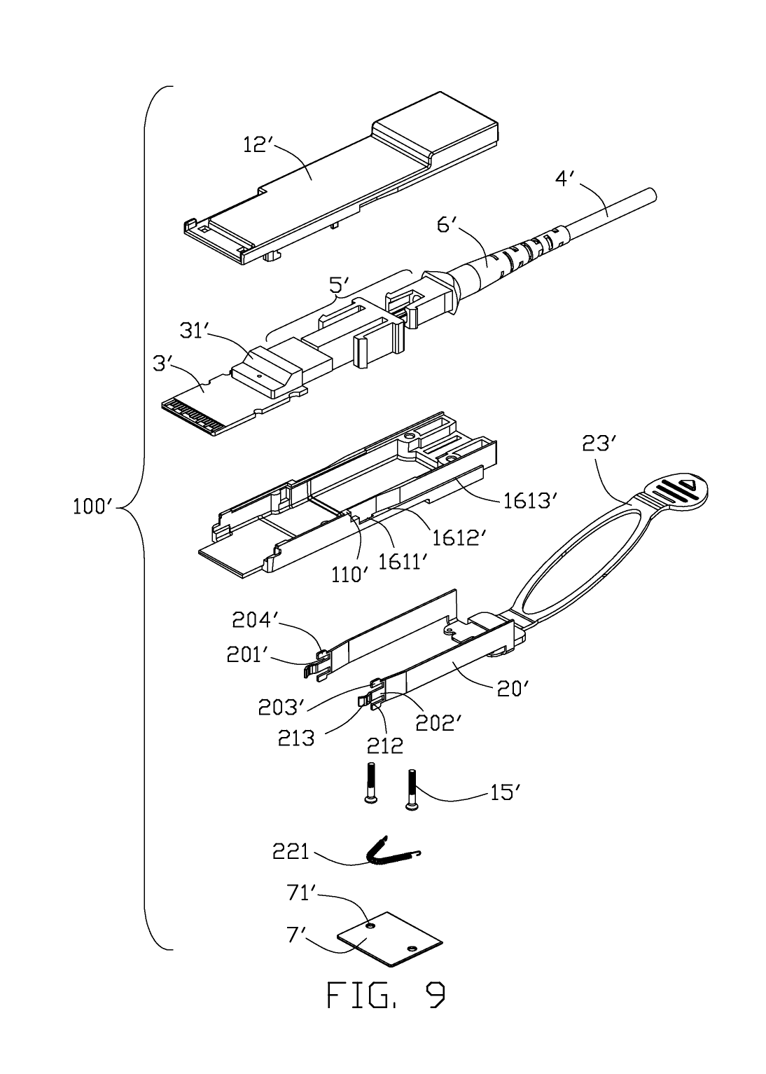

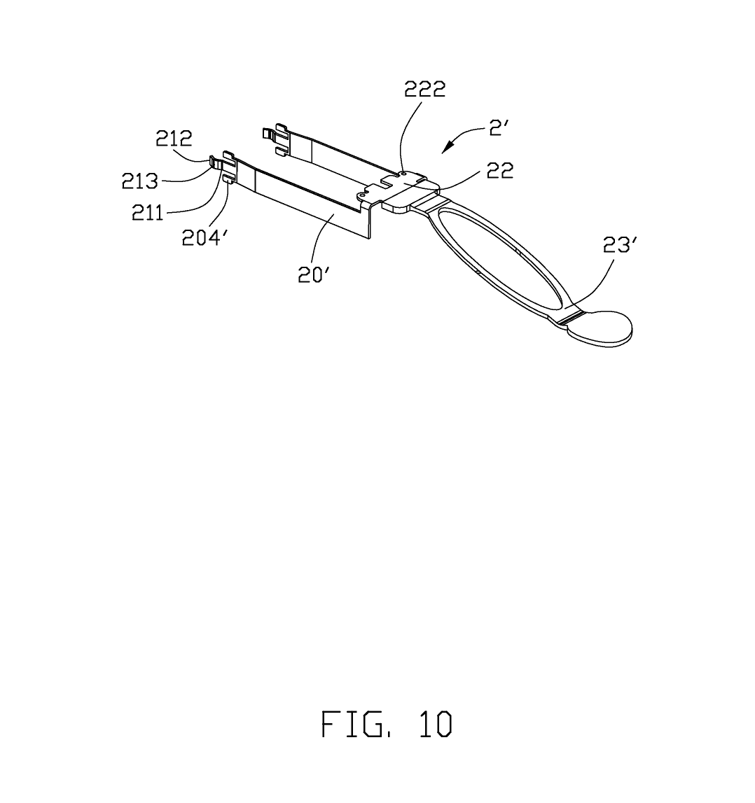

Referring to FIGS. 6 to 11 as a second embodiment of a plug connector 100′ configured for latching engagement with a receptacle cage (not shown) having an inwardly extending latching tab (not shown). The plug connector 100′ in accordance with the present invention comprises a housing 1′ having a base 12′ and a cover 11′ attached to an upper portion of the base 12′, and a releasing mechanism 2′ assembled to the housing 1′ which includes a pair of substantially parallel actuator arms 20′. The base 12′ defines a receiving space (not labeled). The plug connector 100′ further includes a printed circuit board 3′ received in the receiving space, a resilient member 221 assembled to the cover 11′, an optical member 31′, and an optical cable 4′ having a plurality of optical fibers (not shown). The optical member 31′ is located around the area of the printed circuit board 3′. A mechanical member 5′ is located behind the optical member 31′ which is used to fix the optical cable 4′. There is a boot 6′ encloses a front portion of the optical cable 4′.

The housing 1′ of the plug connector 100′ has a front portion 13 configured for connecting with the printed circuit board 3′ to achieve electrical transmission with the receptacle cage (not shown), and a rear portion 14′ configured for connecting with the optical cable 4′. The housing 1′ is preferably made by metal material. The base 12′ and the cover 13′ have opposite mating surfaces 110′,120′ thereof. The base 12′ is mated with the cover 13′ by at least one holding member 15′. In this embodiment, the holding member 15′ is screw. The housing 1′ also normally includes a top wall 17′ and two opposite sidewalls 16′. The top wall 17′ of the housing 1′ defines a resisting part 171′ and a stepped portion 173′. A curved slot 175′ is formed between the resisting part 171′ and the stepped portion 173′. The resilient member 221 has two free ends could be received in the curved slot 175′. Accordingly, each of the free ends of the resilient member 221 has a hook (not labeled) adapted for hooking the releasing mechanism 2′ directly. In this design, the resilient member 221 is a compression spring. In the preferred embodiment, both the resilient member 221 and the curved slot 175′ are designed into a V-shaped. Typically, in accordance with the present invention, the resilient member 221 and the curved slot 175′ could be respectively designed into a U-shaped (or other shapes) configuration with the similar effect. The resilient member 221 would be in an extended state when it is moved from a latching position to a releasing position. Meanwhile, when the actuator arms 20′ are located at the releasing position, the compression spring could provide a return force to restore the actuator arms 20′ to the latching position. A plate 7′ is mounted onto the housing 1′ adapted for covering the curved slot 175′. The plate 7′ covers the compression spring for preventing the resilient member 221 escaping from the curved slot 175′. The plate 7′ defines at least one mounting hole 71′ for receiving the holding member 15′. The holding member 15′ could be locked onto the resisting part 171′ or the stepped portion 173′. In the embodiment, the holding member 15′ is screwed through the mounting hole 71′ to fasten the cover 11′ to the base 12′ by riveting or soldering or screw connection.

Each of the sidewalls 16′ defines an indentation 163′ opening towards the rear portion 14′, and an elongated recess 161′ located at an outer surface thereof extending along a front-to-rear direction from the indentation 163′. A width of the indentation 163′ is smaller than a width of the recess 161′ to form a shoulder portion 162′. The latching tap resists the shoulder portion 162′ so that the plug connector 100′ could be latched with the receptacle cage.

The releasing mechanism 2′ is formed by stamping and bending a piece of metal sheet. Each of the actuator arms 20′ of the releasing mechanism 2′ comprises a horizontal portion 22 having a plurality of holes 222 for connecting with the resilient member 221, and a pull member 23′ attached to the horizontal portion 22′. In this embodiment, the pull member 23′ is designed as a ring-shaped which could make the optical cable 4 therethrough. Each of the actuator arms 20′ comprises a narrowed and protruded actuating end 21′ adapted for releasing the latching tab of the receptacle cage when the actuator arm 20′ moves from the latching position to the releasing position, and defining slits 201′ along the rearwardly direction to increase a length of the elastic deformation of the actuating end 21′. In this embodiment, each of the actuating arms 20′ defines a pair of slits 201′. Without a doubt, each of the actuating arms 20′ could have a slit 201′ or more. The actuator end 21′ is adjacent to the slit 201′, the pair of slits 201′ being defined axial symmetry with each other. Each of the actuator arms 20′ further includes a first part 202′ extending forwardly from the actuator arm 20′ and between the pair of slits 201′, a second part 203′ located at the outside of the slit 201′. The first part 202′ and the second part 203′ are separated at the front of the actuating arm 20′. The first part 202′ has a width measured along an up-to-down direction equal to a width of the actuating end 21′ along the direction. In this embodiment, the actuating end 21′ has an arc-shaped comprising a connecting portion 211, a bulge portion 212 connected with the connecting portion 211 and a tail end 213.

A pair of tabs 204′ are formed at the outside of the second part 203′ of each actuator arms 20′. Typically, each of the actuating arms 20′ may have one tab 204′ or more tabs 204′ as long as it is contribute to make the latching tabs separate from the plug connector 100′. Each of the sidewalls 16′ has a limiting groove 1611′ for receiving corresponding tab 204′. The limiting groove 1611′ has a resisting wall 1614′. When the actuator arms 20′ move backwardly from a latching position to a releasing position, the resisting wall 1614′ of the limiting groove 1611′ could make the tab 204′ received in the limiting groove 1611′. The limiting groove 1611′ locates at the front of the recess 161′. The recess 161′ further includes a channel 1613′ locates at a rear end of the recess 161 and an inclined groove 1612′ connecting with the limiting groove 1611′ and channel 1613′. The depth of the channel 1613′ is smaller than the limiting groove 1611′. In this description, each of the actuator arms 20′ defines a pair of tabs 204′.

In this description, each of the actuator arms 20′ defines slits 201′ extending rearwardly beside the actuating end 21′ to increase an elastic deformation length of the actuating end 21′ so as to the latching tab could be stretched enough. Further, it is convenient to release the latching tab to allow the extraction of the plug connector 100′.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A plug connector configured for latching engagement with a receptacle cage having an inwardly extending latching tab, comprising:
a housing comprising a top wall, a bottom wall opposite to the top wall, and two opposite sidewalls connecting with the top wall and the bottom wall, the top wall extending a preselected length to define a first flange and the bottom wall extending a preselected length to define a second flange, a width of the first flange being smaller than a width of the second flange;
a releasing mechanism assembled to the housing, the releasing mechanism comprising a pair of actuator arms movably attached to the sidewalls along a mating direction of the plug connector and a horizontal portion integrally connected between the actuator arms.

2. The plug connector as claimed in claim 1, wherein the actuator arm comprises an arcuate bend portion linking to the horizontal portion.

3. The plug connector as claimed in claim 2, wherein the bend portion lies on a vertical main plane of the actuator arm.

5. The plug connector as claimed in claim 1, wherein the releasing mechanism comprises a pull member attached to the horizontal portion.

6. The plug connector as claimed in claim 1, wherein the releasing mechanism comprises two protrusion portions extending toward the top wall and a connecting portion connected between the two protrusion portions.

7. The plug connector as claimed in claim 6, wherein the connecting portion comprises a first portion and a second portion engaged with the first portion.

8. The plug connector as claimed in claim 1, wherein each of the actuator arms comprises at least one tab disposed at a front portion of the actuator arm, and each of the sidewalls defines a limiting groove for receiving a corresponding tab.

9. The plug connector as claimed in claim 1, wherein the actuator arm has an actuating end extending forwardly and a pair of slits extending rearwardly beside the actuating end to increase an elastic deformation length of the actuating end.

10. The plug connector as claimed in claim 9, wherein each of the actuator arms comprises a first part located between the slits and a second part located outside of the slits, the first part having a width measured along an up-to-down direction equal to a width of the actuator end along the direction.

11. A plug connector for latching into a receptacle cage with a pair of resilient inwardly extending locking tabs, comprising:
a housing defining opposite top and bottom walls in a first direction and a pair of opposite sidewalls in a second direction perpendicular to said first direction to commonly defining a receiving space with a mating port located in a front portion of the receiving space, said top wall defining a first flange and said bottom wall defining a second flange, said first flange being smaller than said second flange in the second direction;
a releasing mechanism attached to the housing and back and forth moveable relative to the housing along a third direction perpendicular to both said first direction and said second direction, said releasing mechanism defining at least one actuating arm located upon one of the sidewalls.

12. The plug connector as claimed in claim 11, wherein a printed circuit board is positioned in the mating port with a dimension between those of the first flange and the second flange in the second direction.

13. The plug connector as claimed in claim 11, wherein said releasing mechanism includes two said actuating arms respectively located on two sidewalls and linked by a horizontal portion where forces are applied to move releasing mechanism.

14. The plug connector as claimed in claim 13, wherein the releasing mechanism comprises a pull member attached to the horizontal portion.

15. The plug connector as claimed in claim 13, wherein said releasing mechanism further includes a connecting portion linked between said two actuating arms and opposite to said horizontal portion in said first direction.

16. The plug connector as claimed in claim 13, wherein each of said actuating arms defining at a front end region thereof an actuating end and a restriction tab with a slit therebetween in the third direction; wherein said actuating end is adapted to urge the corresponding locking tab outwardly in the second direction for unlocking the plug connector from the receptacle cage when the plug connector and the receptacle cage are mated with each other while the restriction tab defines an edge region received in a limiting groove of the housing to restrict the front end region of the actuating arm from moving in the second direction.

17. The plug connector as claimed in claim 16, wherein each of the actuating arms includes two said restriction tabs respectively located by two sides of the actuating end in the first direction each with the corresponding slit therebetween.

18. The plug connector as claimed in claim 16, wherein said limiting groove extends along the third direction to allow the edge region of the restriction tab to back and forth move therein.
